(19) United States
(12) Patent Application Publication
(10) Pub. No.: US 2019/0259027 A1
(43) Pub. Date: Aug. 22, 2019

(54) COMPUTER SYSTEM AND COMPUTER-IMPLEMENTED METHOD FOR IMPORTING PAYEE DETAILS

(71) Applicant: Mastercard International Incorporated, Purchase, NY (US)

(72) Inventor: Akash Chopra, Pune (IN)

(73) Assignee: Mastercard International Incorporated, Purchase, NY (US)

(21) Appl. No.: 16/247,939

(22) Filed: Jan. 15, 2019

(30) Foreign Application Priority Data
Feb. 22, 2018 (SG) 10201801447Q

(51) Int. Cl. G06Q 20/38; G06Q 20/40

(52) U.S. Cl. CPC G06Q 20/388; G06Q 20/4014; G06Q 20/3821

(57) ABSTRACT

Computer System and Computer-Implemented Method for Importing Payee Details An intermediary server for importing payee details into an account associated with a user is described. The intermediary server comprises a transfer module, an inquiry module and an export request module. The transfer module is configured to: (i) receive, from an issuer server, a transfer request comprising a request to import payee details from another issuer server and at least an account identifier and an issuer identifier associated with the another issuer server; and (ii) transmit, to the issuer server, a transfer response comprising the payee details associated with the another issuer server. The inquiry module is configured to query an intermediary database to identify the another issuer server using the issuer identifier. The export request module is configured to: (i) transmit, to the another issuer server an export request to export the payee details from the another issuer server and comprises at least the account identifier; and (ii) receive, from the another issuer server, an export response comprising the payee details.

### CROSS REFERENCE TO RELATED APPLICATIONS

This application claims priority to Singaporean Application Serial No. 10201801447Q, filed Feb. 22, 2018, which is incorporated herein by reference in its entirety

### FIELD OF THE INVENTION

The present invention relates to a computer system and computer-implemented method for importing payee details. In particular, the invention relates to importing payee details between different financial institutions.

### BACKGROUND OF THE INVENTION

It is commonplace for users of financial services to hold accounts with more than one financial institution. Financial institutions (e.g. banks) often attract users to start a banking relationship with them by providing various perks and rewards when they register to use their services. The perks and rewards attract users to register multiple accounts at different financial institutions. Moreover, as a result of recent financial crises which led to the collapses of several banks, users typically hold accounts at more than one financial institution so as to improve security of their assets. Furthermore, each user may use a different institution for each of different financial services (e.g. a home loan, an insurance scheme or a trading platform etc.). In order to use such services, the user may need to register at least one account with the financial institution.

Coupled with the widespread of internet banking, users who hold multiple accounts may find themselves making regular payments using different accounts via the internet. These users typically have a common list of payees stored in association with each internet banking account. In the event that a new account is registered at a new financial institution, the user will have to provide the payee details again so that payments can be made to this list of payees using the new account. This is often a cumbersome process since the payee details (e.g. payee's name, payee's account number, IBAN or Sort Code or Indian Financial System Code (IFSC) etc.) have to be re-entered for the new account, and it is especially inconvenient if the payee details are not readily available to the user.

It is therefore an aim of the present invention to provide a computer system and computer-implemented method to improve convenience for importing payee details into an account.

### SUMMARY OF THE INVENTION

In accordance with a first aspect of the present invention, there is provided an intermediary server for importing payee details into an account associated with a user. The intermediary server comprising:
a transfer module configured to:
   receive, from an issuer server, a transfer request comprising a request to import payee details from another issuer server and at least an account identifier and an issuer identifier associated with the another issuer server; and
   transmit, to the issuer server, a transfer response comprising the payee details associated with the another issuer server; and
an inquiry module configured to:
   query an intermediary database to identify the another issuer server using the issuer identifier; and
an export request module configured to:
   transmit, to the another issuer server an export request to export the payee details from the another issuer server, the export request comprising at least the account identifier; and
   receive, from the another issuer server, an export response comprising the payee details.

Embodiments of the invention therefore provide an intermediary server that can be used for importing payee details into an account. In particular, the intermediary server facilitates transfer of payee details to a first account associated with a first issuer server from a second account associated with a second issuer server. The intermediary server receives a transfer request to import payee details from the first issuer server. The transfer request comprises at least an account identifier and an issuer identifier associated with the second issuer server. An inquiry module comprised in the intermediary server is configured to query an intermediary database to identify the second issuer server using the issuer identifier, and an export request module comprised in the intermediary server is configured to subsequently request export of the payee details from the second issuer server to the first issuer server via the intermediary server. This allows a user to share registered payee details across multiple accounts associated with the user that are maintained at different issuers and thereby minimising the inconvenience typically experienced by the user to re-register the payee details individually for each of his/her accounts. Moreover, the intermediary server functions as a central platform which facilitates transfer of information between different issuer servers such that the first issuer server needs only to register with the intermediary server for performing importation of the payee details. In some embodiments where the intermediary server is a payment network server, the issuer servers which have already registered with the payment network server are not required to re-register with the payment network server to provide the service of importing payee details into an account.

In addition, embodiments of the invention may advantageously use present infrastructure for importing payee details across different accounts so that minimal costs will be incurred to implement the above. The present invention may also be incorporated into a mobile/internet banking application (App) on a user electronic device associated with the user such that importing of payee details may be performed via the App. In other words, the user who is logged into the App for the first account may, via the App, request importing of payee details from the second account into the first account.

Where the payee details comprise a list of payees associated with the another issuer server, the transfer module may be configured to:
transmit, to the issuer server, a selection request comprising a request to select from the list of payees, at least one payee, the payee details for which are to be imported to the issuer server; and
receive, from the issuer server, a selection response comprising the at least one payee; and
wherein the export request module may be configured to:
   transmit, to the another issuer server, a selected export request comprising a request to export selected payee details associated with the at least one payee; and
   receive, from the another issuer server, a selected export response comprising the selected payee details.

The intermediary server may comprise an authentication module configured to:
receive, from the another issuer server, an authentication request comprising a request to authenticate the user;
transmit, to the issuer server, a user authentication request comprising a request for user details, the user details being associated with the another issuer server;
receive, from the issuer server, a user authentication response comprising the user details; and
transmit, to the another issuer server, an authentication response comprising the user details to authenticate the user.

In accordance with a second aspect of the present invention, there is provided an issuer server for importing payee details into an account associated with a user. The issuer server comprising:
an import request module configured to:
   receive, from a user electronic device, an import request, the import request is a request to import payee details from another issuer server and comprises at least an account identifier and an issuer identifier associated with the another issuer server; and
   transmit, to the user electronic device, an import response comprising the payee details associated with the another issuer server; and
a transfer request module configured to:
   transmit, to an intermediary server, a transfer request, where the transfer request is a request to import the payee details from the another issuer server and comprises at least the account identifier and the issuer identifier; and
   receive, from the intermediary server, a transfer response comprising the payee details associated with the another issuer server.

Where the payee details comprise a list of payees associated with the another issuer server, the import request module may be configured to:
transmit, to the user electronic device, a payee selection request comprising a request to select from the list of payees, at least one payee, the payee details for which are to be imported to the account; and
receive, from the user electronic device, a payee selection response comprising the at least one payee.

The issuer server may comprise:
a user authentication module configured to:
   receive, from the intermediary server, a user authentication request comprising a request to authenticate the user;
   transmit, to the user electronic device, a transfer authentication request comprising a request for user details associated with the another issuer server to authenticate the user;
   receive, from the user electronic device, a transfer authentication response comprising the user details associated with the another issuer server; and
   transmit, to the another issuer server, a user authentication response comprising the user details.

In accordance with a third aspect of the present invention, there is provided a computer-implemented method for importing payee details into an account associated with a user, the method being carried out by an intermediary server and comprises:
receiving, from an issuer server, a transfer request comprising a request to import payee details from another issuer server and at least an account identifier and an issuer identifier associated with the another issuer server;
querying an intermediary database to identify the another issuer server using the issuer identifier;
transmitting, to the another issuer server an export request to export the payee details from the another issuer server, the export request comprising at least the account identifier;
receiving, from the another issuer server, an export response comprising the payee details; and
transmitting, to the issuer server, a transfer response comprising the payee details associated with the another issuer server.

Where the payee details comprise a list of payees associated with the another issuer server, the method may comprise:
transmitting, to the issuer server, a selection request comprising a request to select from the list of payees, at least one payee, the payee details for which are to be imported to the issuer server;
receiving, from the issuer server, a selection response comprising the at least one payee;
transmitting, to the another issuer server, a selected export request comprising a request to export selected payee details associated with the at least one payee; and
receiving, from the another issuer server, a selected export response comprising the selected payee details.

The method may comprise:
receiving, from the another issuer server, an authentication request comprising a request to authenticate the user;
transmitting, to the issuer server, a user authentication request comprising a request to provide user details, the user details being associated with the another issuer server;
receiving, from the issuer server, a user authentication response comprising the user details; and
transmitting, to the another issuer server, an authentication response comprising the user details to authenticate the user.

In accordance with a fourth aspect of the present invention, there is provided a computer-implemented method for importing payee details into an account associated with a user, the method being carried out by an issuer server and comprises:
receiving, from a user electronic device, an import request, the import request is a request to import payee details from another issuer server and comprises at least an account identifier and an issuer identifier associated with the another issuer server;
transmitting, to an intermediary server, a transfer request, where the transfer request is a request to import the payee details from the another issuer server and comprises at least the account identifier and the issuer identifier;
receiving, from the intermediary server, a transfer response comprising the payee details associated with the another issuer server; and
transmitting, to the user electronic device, an import response comprising the payee details associated with the another issuer server.

Where the payee details comprise a list of payees associated with the another issuer server, the method may comprise:
transmitting, to the user electronic device, a payee selection request comprising a request to select from the list of payee, at least one payee, the payee details for which are to be imported to the account; and
receiving, from the user electronic device, a payee selection response comprising the at least one payee.

The method may comprise:
receiving, from the intermediary server, a user authentication request comprising a request to authenticate the user;
transmitting, to the user electronic device, a transfer authentication request comprising a request for user details associated with the another issuer server to authenticate the user;
receiving, from the user electronic device, a transfer authentication response comprising the user details associated with the another issuer server; and
transmitting, to the another issuer server, a user authentication response comprising the user details.

In accordance with a fifth aspect of the present invention, there is provided a computer-implemented method for importing payee details into an account associated with a user, the method being carried out by a user electronic device and comprises:
receiving, an import payee request to import payee details to the account from another account associated with another issuer server, the import payee request comprising at least an issuer identifier associated with the another issuer server;
transmitting, to an issuer server, an import request, the import request is a request to import the payee details from the another issuer server and comprises at least an account identifier associated with the another issuer server and the issuer identifier;
receiving, from the another issuer server, an import authentication request comprising a request for user details associated with the another issuer server to authenticate the user;
transmitting, to the another issuer server, an import authentication response comprising the user details; and
receiving, from the issuer server, an import response comprising the payee details associated with the another issuer server if the user details are authenticated.

The account identifier may comprise at least one of an account number or an account name associated with the another issuer server.

The export request or the selected export request may further comprise an export parameter indicating that the export request or the selected export request is a request to export the payee details or the selected payee details respectively.

The payee details may comprise at least a name of a payee and an account number associated with the payee or any other information necessary for the user to perform a fund transfer to the payee from his/her account.

In accordance with a sixth aspect of the present invention, a non-transitory computer-readable medium having stored thereon program instructions for causing at least one processor to perform the preceding methods.

The present invention aims to provide a new and useful computer system and computer-implemented method for importing payee details into an account associated with a user.

### BRIEF DESCRIPTION OF THE DRAWINGS

Non-limiting embodiments of the invention will now be described for the sake of example only, with reference to the following drawings in which:

FIG. 1 shows a computerised system for importing payee details into an account associated with a user in accordance with an embodiment of the invention;

FIG. 2 shows steps of a method for importing payee details into an account carried out by an intermediary server in accordance with an embodiment of the invention;

FIG. 3 shows steps of a method for importing payee details into an account carried out by an intermediary server in accordance with an embodiment of the invention;

FIG. 4 shows steps of a method for authenticating a user carried out by an intermediary server in accordance with an embodiment of the invention;

FIG. 5 shows steps of a method for importing payee details into an account carried out by an issuer server in accordance with an embodiment of the invention;

FIG. 6 shows steps of a method for importing payee details into an account carried out by an issuer server in accordance with an embodiment of the invention;

FIG. 7 shows steps of a method for authenticating a user in accordance with an embodiment of the invention;

FIG. 8 shows steps of a method for importing payee details into an account carried out by a user electronic device in accordance with an embodiment of the invention;

FIG. 9 shows schematically a functional structure of an intermediary server which may be used in the computerised system as shown in FIG. 1 in accordance with an embodiment of the invention;

FIG. 10 shows schematically a functional structure of an issuer server which may be used in the computerised system as shown in FIG. 1 in accordance with an embodiment of the invention; and

FIG. 11 shows schematically a hardware structure of a server which may be used in the computerised system of FIG. 1 to implement a method in accordance with an embodiment of the invention.

### DETAILED DESCRIPTION OF THE EMBODIMENT

As used in this document, the term “account” refers to any payment account maintained by a financial institution, the account may be associated with a payment vehicle such as a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, transponder devices, NFC-enabled devices, and/or computers.

Note that the term “institution” is used here in a sense which is not necessarily limited to organizations which are legally constituted as banks, since in some jurisdictions other organizations may be permitted to maintain financial accounts such as a payment account. An institution may be one of the following: a bank, a financial technology company, a telecommunication company or a financial institution.

As used in this application, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

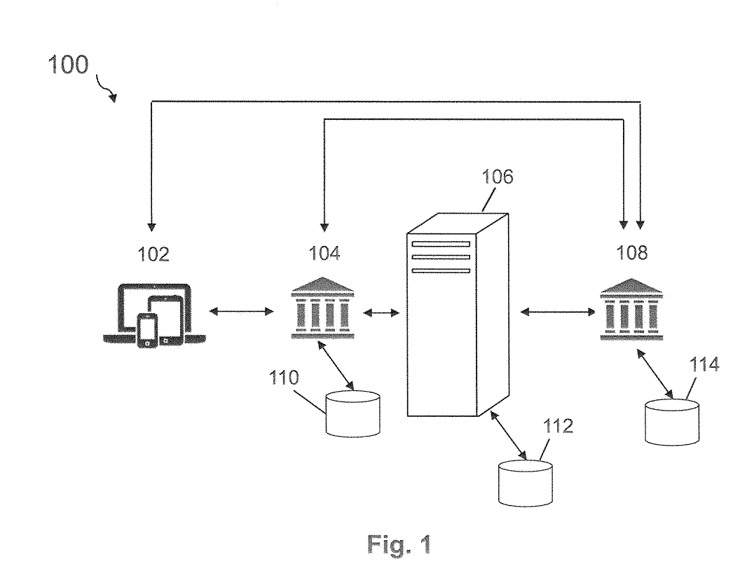

FIG. 1 shows a computerised system 100 for importing payee details into an account associated with a user in accordance with an embodiment of the invention. The computerised system 100 comprises an intermediary server 106 which serves as a central platform to facilitate transfer of information between an issuer server 104 and another issuer server 108. The intermediary server 106 may be a payment network server associated with a payment network such as the Banknet payment network operated by MasterCard®. In some embodiments, the intermediary server is a third party server associated with a service provider which manages accounts. As shown in FIG. 1, the intermediary server 106 is in communication with the issuer server 104 and the another issuer server 108. The issuer server 104 and the another issuer server 108 are associated with a first issuer institution and a second issuer institution respectively, each of which maintains an account for the user. The account may be a payment account which can be used to perform payment transactions (e.g. card-not-present transactions) over a payment network. In some embodiments, the issuer server 104 is in communication with the another issuer server 108.

The computerised system 100 further comprises a user electronic device 102. The user electronic device 102 may be any electronic device which enables the user to access his/her account. In some embodiments, the user electronic device comprises an application (“App”) which allows the user to log in to his/her account e.g. associated with the issuer server 104 electronically. The user electronic device 102 may be a mobile phone, a laptop/notebook, a desktop, a tablet, a personal digital assistants (PDA), a key fob, a transponder device, a NFC-enabled device, and/or a computer. Moreover, a first issuer database 110 and a second issuer database 114 is operationally connected to the issuer server 104 and the another issuer server 108 respectively. The first issuer database 110 serves at least to store data related to a first account associated with the user which is issued by the first issuer institution, while the second issuer database 114 serves at least to store data related to a second account associated with the user which is issued by the second issuer institution. Data related to the first or second account may comprise user detail such as a user name or identification, a password or a personal identification number (PIN) associated with the user (this PIN may be unique to each account or it may be the same for the different accounts, depending on a choice of the user), payee details associated with the first or the second account etc. The first issuer database 110 and the second issuer database 114 may store contact information (e.g. mobile phone number, addresses, electronic mails etc.) associated with the user. Furthermore, an intermediary database 112 is operationally connected to the intermediary server 106 which serves to at least store information associated with issuer institutions (e.g. information related to matching an issuer server/issuer institution to an issuer identifier). The intermediary database 112 may also store transfer information related to records/transactions of importation of payee details from one account to another account.

Compared to conventional manual methods for adding payees to an account, the present invention provides a system and method to transfer payee details from one account (e.g. the first account) to another (e.g. the second account) without the inconvenience of re-entering by the user the required payee details at the second account, thereby improving convenience for the user in transferring payee details between different accounts. In some embodiments, once the user is logged into the first account with his/her credentials (e.g. a user name, a password or a PIN or other form of identification etc.), one of the services presented to the user is an option to import payees from another account maintained by another issuer institution. The option may be presented to the user as a new function or a tab on a menu of the first account (e.g. shown in the App or a web page). In some embodiments, once the user has selected the option to import payees, a list of financial institutions is displayed. The list of financial institutions may be pre-loaded in the first issuer server 104 which comprises a list of financial institutions commonly used in a respective jurisdiction. For example if the issuer server 104 is associated with the first issuer institution which is located in Singapore, the list of financial institutions may comprise Overseas-Chinese Banking Corporation™ (OCBC), United Overseas Bank™ (UOB), The Development Bank of Singapore™ (DBS), Citibank™, the Hong Kong and Shanghai Banking Corporation™ (HSBC), Maybank™ etc. The user is required to select a financial institution from the list of financial institutions to import payee details. The user may select one or more financial institution from the list.

Once the user has selected the financial institution(s), the user may be prompted to input user details to authenticate the user access to the account(s) associated with the selected financial institution(s). In an example, with reference to FIG. 1, where the user has selected to import payee details from a second financial institution associated with the another issuer server 108, the user is prompted to input user details associated with the another issuer server 108. In some embodiments, where the user has selected more than one financial institutions for importing payee details, the user may be prompted to input necessary user details corresponding to each of the more than one financial institutions. The user details entered via the user electronic device 102 are transmitted to the another issuer server 108 either via the issuer server 104 directly, or via the intermediary server 106. In any case, the user is authenticated by the another issuer server 108 using the user details. Once the user is authenticated, a list of payees associated with the user that is registered with the another issuer server 108 may be displayed. In some embodiments, a confirmation input for importing the list of payees is prompted after the user is authenticated but prior to displaying the list of payees to the user. Once the list of payees is displayed, the user may select one or more payees to be imported to the first account. In some embodiments, there may be a checkbox associated with each of the payees where the user can check to select the payees. In other embodiments, payees can be selected by clicking on the payees where the selected payees will appear highlighted or bold. Once the payees are selected, the user may import the payee details associated with the selected payees to the first account (e.g. this may be done by effecting an option to import the payees as displayed on the user electronic device 102).

In some embodiments, the user may not be presented with the list of payees once the user is authenticated. In these cases, all registered payee information associated with the selected financial institution(s) may be transferred to the issuer server 104 once the user has been authenticated. The user may then select some or all of the registered payees imported to the first issuer server 104 to be associated with the first account.

Although only one user electronic device 102 is shown in FIG. 1, a plurality of user electronic devices 102 may form part of the computerised system 100. Similarly, a plurality of issuer servers 104 and a plurality of another issuer servers 108 may be in communication with the intermediary server 106 and form part of the computerised system 100. Communication between the user electronic device 102, servers and databases may take place via any type of system, for example, a virtual private system (VPN), the Internet, a local area and/or wide area system (LAN and/or WAN).

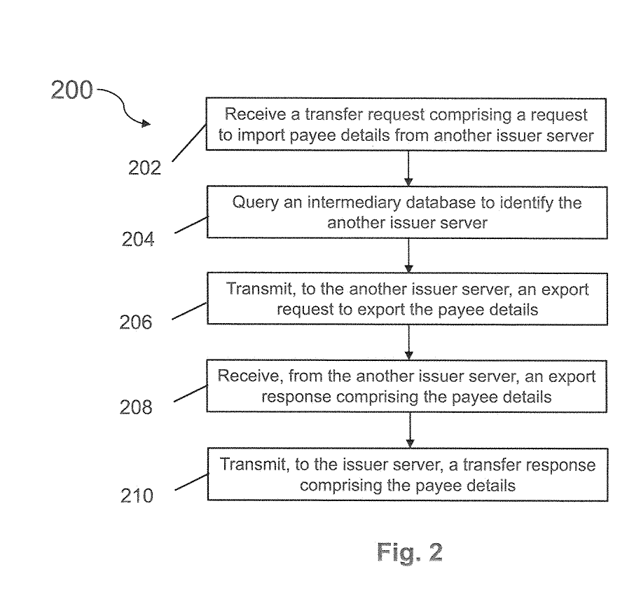

FIG. 2 shows steps of a method 200 for importing payee details into an account associated with the user as carried out by the intermediary server 106 in accordance with an embodiment of the invention. The account may be the first account associated with the issuer server 104 described previously in conjunction with FIG. 1.

In a step 202, the intermediary server 106 is configured to receive a transfer request from the issuer server 104. The transfer request comprises a request to import payee details from the another issuer server 108 and at least an account identifier and an issuer identifier associated with the another issuer server 108. The account identifier may comprise at least one of an account number or an account name associated with the another issuer server 108. The issuer identifier may be an international bank account number (IBAN), a bank sort code or a SWIFT code or any similar identifier which can uniquely identify a financial institution.

In a step 204, the intermediary server 106 is configured to query the intermediary database 112 to identify the another issuer server 108 using the issuer identifier. The intermediary database 112 may comprise issuer information relating a plurality of issuer institutions to their corresponding issuer identifiers. Issuer information may be stored in the intermediary database 112 when issuer institutions registered with the intermediary server 106 for a service of importing payee details or any other services provided by the intermediary server 106.

In a step 206, the intermediary server 106 is configured to transmit, to the another issuer server 108, an export request to export the payee details from the another issuer server 108. The export request comprises at least the account identifier. In some embodiments, the account identifier is used by the another issuer server 108 to identify the account maintained at the another issuer server 108 which is associated with the user. This may be done by querying the second issuer database 114 associated with the another issuer server 108 using the account identifier. In some embodiments, the export request comprises an export parameter indicating that the export request is a request to export the payee details. This aids the another issuer server 108 to identify the export request as a request to export the payee details when it is received from the intermediary server 106 so that the export request may be processed accordingly.

In a step 208, the intermediary server 106 is configured to receive, from the another issuer server 108, an export response comprising the payee details. The payee details may comprise details of a plurality of payees, each of which may comprise at least a name of the payee and an account number associated with the payee. The payee details may comprise other information necessary for the user to perform a fund transfer to the payee from his/her account.

In a step 210, the intermediary server 106 is configured to transmit, to the issuer server 104, a transfer response comprising the payee details associated with the another issuer server 108. The payee details may be transmitted by the intermediary server 106 to the issuer server 104 in a format which is acceptable by the issuer server 104. In some embodiments, there is a standard format in which payee details may be transmitted from one issuer server (e.g. the another issuer server 108) to another issuer server (e.g. the issuer server 104) via the intermediary server 106. In this case, the payee details may be in the standard format when it is received from the another issuer server 108. In some embodiments, the payee details comprises a list of payees associated with the another issuer server 108.

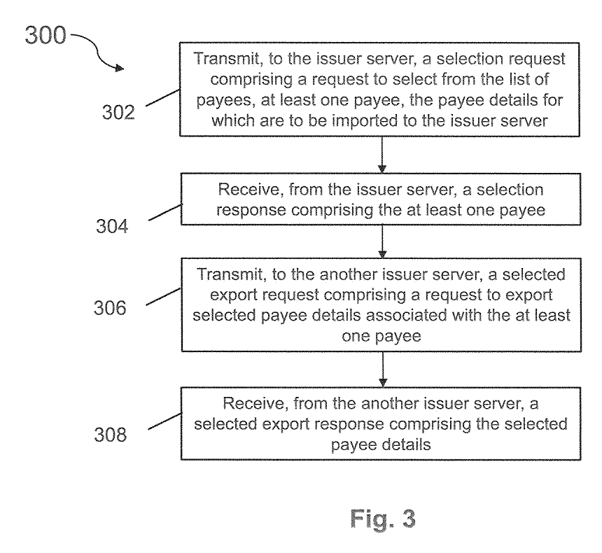

FIG. 3 shows steps of a method 300 for importing payee details into the account associated with the user as carried out by the intermediary server 106 in accordance with an embodiment of the invention. The method 300 is carried out where the payee details received from the another issuer server 108 in the step 208 comprises a list of payees associated with the another issuer server 108.

In a step 302, the intermediary server 106 is configured to transmit, to the issuer server 104, a selection request comprising a request to select from the list of payees, at least one payee, the payee details for which are to be imported to the issuer server 104. In some embodiments, the step 302 is comprised in the step 210 such that the selection request is transmitted to the issuer server 104 together with or as part of the transfer response. In some embodiments, the step 302 is performed after the step 210.

In a step 304, the intermediary server 106 is configured to receive, from the issuer server 104, a selection response comprising the at least one payee.

In a step 306, the intermediary server 106 is configured to transmit, to the another issuer server 108, a selected export request comprising a request to export selected payee details associated with the at least one payee. In some embodiments, the selected export request comprises the export parameter indicating that the selected export request is a request to export the selected payee details. This aids the another issuer server 108 to identify the selected export request as a request to export the selected payee details when it is received from the intermediary server 106 so that the selected export request may be processed accordingly.

In a step 308, the intermediary server 106 is configured to receive, from the another issuer server 108, a selected export response comprising the selected payee details. The intermediary server 106 may be configured to transmit the selected export response to the issuer server 104 at the end of the step 308. In this case, only the selected payee details are transmitted to the issuer server 104 to be associated with the first account maintained at the issuer server 104.

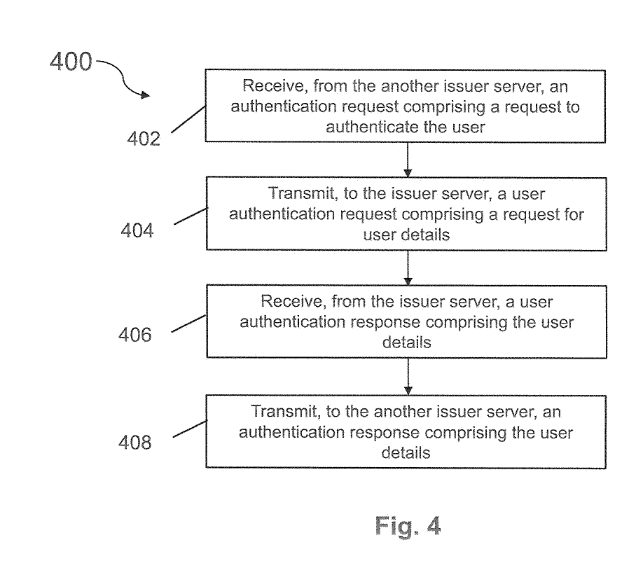

FIG. 4 shows steps of a method 400 for authenticating the user carried out by the intermediary server 106 in accordance with an embodiment of the invention. The method 400 may be used to authenticate the user prior to fulfilling the export request by the another issuer server 108. In other words, the method 400 may be carried out after the export request is received at the another issuer server 108 in the step 206 and before the export response is transmitted from the another issuer server 108 to the intermediary server 106 in the step 208.

In a step 402, the intermediary server 106 is configured to receive, from the another issuer server 108, an authentication request comprising a request to authenticate the user.

In a step 404, the intermediary server 106 is configured to transmit, to the issuer server 104, a user authentication request comprising a request for user details, the user details being associated with the another issuer server 108. The user details may comprise at least a user name associated and a personal identification number (PIN) or a password associated with the user which is registered with the another issuer server 108. The PIN or password may comprise a string of numbers, symbols or alphanumeric characters. In some embodiments, the PIN may consist of a string of 3 or 4 numbers.

In a step 406, the intermediary server 106 is configured to receive, from the issuer server 104, a user authentication response comprising the user details.

In a step 408, the intermediary server 106 is configured to transmit, to the another issuer server 108, an authentication response comprising the user details to authenticate the user. Upon receiving the user details from the intermediary server 106, the another issuer server 108 may be configured to verify the user details using the second issuer database 114. The user may be authenticated by the another issuer server 108 if the user details received from the intermediary server 106 match those stored in the second issuer database 114.

In some embodiments, a second-factor authentication process is used to further authenticate the user prior to processing the export request by the another issuer server 108. The second-factor authentication may comprise the another issuer server 108 transmitting a dynamic one-time password (OTP) to the user electronic device 102. The user is authenticated if the OTP received by the another issuer server 108 is verified by the another issuer server 108. In these cases, the export request is fulfilled (e.g. the step 210 is completed) if the second-factor authentication process is successful.

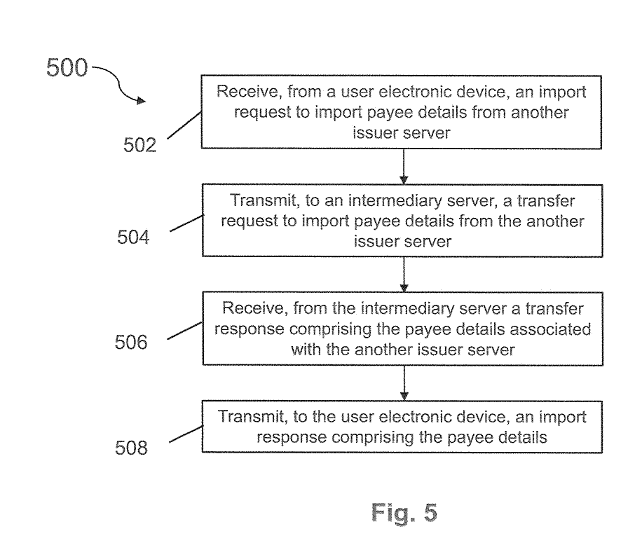

FIG. 5 shows steps of a method 500 for importing payee details into the account associated with the user as carried out by the issuer server 104 in accordance with an embodiment of the invention. The method 500 depicts the steps carried out by the issuer server 104 which complements the steps in the methods 200, 300, 400 carried out by the intermediary server 106 for importing payee details to the first account maintained by the issuer server 104.

In a step 502, the issuer server 104 is configured to receive, from the user electronic device 102, an import request, the import request is a request to import payee details from the another issuer server 108. The import request comprises at least the account identifier and the issuer identifier associated with the another issuer server 108. The import request received from the user electronic device 102 initialises the processes (e.g. the methods 200 to 400) described for importing payee details to the first account. The account identifier may comprise at least one of an account number or an account name associated with the another issuer server 108.

In a step 504, the issuer server 104 is configured to transmit, to the intermediary server 106, a transfer request, where the transfer request is a request to import the payee details from the another issuer server 108. The transfer request comprises at least the account identifier and the issuer identifier. The transfer request transmitted to the intermediary server 106 may be forwarded by the intermediary server 106 to the another issuer server 108 as described in the step 202.

In a step 506, the issuer server 104 is configured to receive, from the intermediary server 106, a transfer response comprising the payee details associated with the another issuer server 108. The transfer response may be received from the intermediary server 106 after the step 208 where the export response is received by the intermediary server 106 from the another issuer server 108.

In a step 508, the issuer server 104 is configured to transmit, to the user electronic device 102, an import response comprising the payee details associated with the another issuer server 108. In some embodiments, the payee details comprises a list of payees associated with the another issuer server 108.

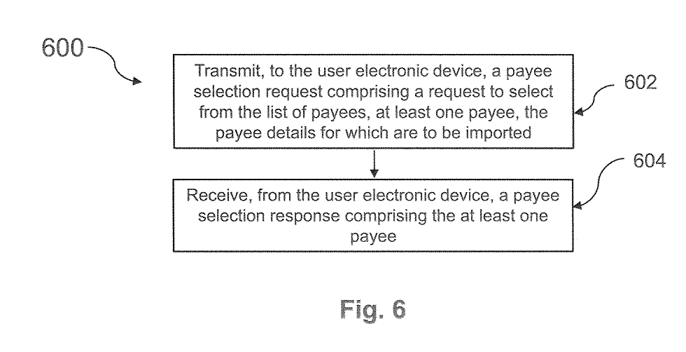

FIG. 6 shows steps of a method 600 for importing payee details into the account associated with the user as carried out by the issuer server 104 in accordance with an embodiment of the invention. The method 600 is carried out where the payee details received from the intermediary server 106 in the step 506 comprises a list of payees associated with the another issuer server 108.

In a step 602, the issuer server 104 is configured to transmit, to the user electronic device 102, a payee selection request comprising a request to select from the list of payee, at least one payee, the payee details for which are to be imported to the account (e.g. the first account maintained at the issuer server 104). In some embodiments, the payee selection request is displayed to the user via the user electronic device 102, where a checkbox is associated with each of the payees on the list of payees. The user may select the at least one payee by checking the checkbox against the desired payee(s). In other embodiments, the at least one payee can be selected by clicking on a name of the at least one payee. In these cases, the selected payee(s) may appear highlighted or bold. In some embodiments, the user is asked to confirm his/her selection once the desired payee(s) are selected. In some embodiments, the step 602 is comprised in the step 508 such that the payee selection request is transmitted to the issuer server 104 together with or as part of the import response. In some embodiments, the step 602 is performed after the step 508.

In a step 604, the issuer server 104 is configured to receive, from the user electronic device 102, a payee selection response comprising the at least one payee. In other words, once the user has selected his/her desired payees to be imported, the payee selection response is transmitted to the issuer server 104 via the user electronic device 102. This may be performed via a suitable App or webpage on the user electronic device 102.

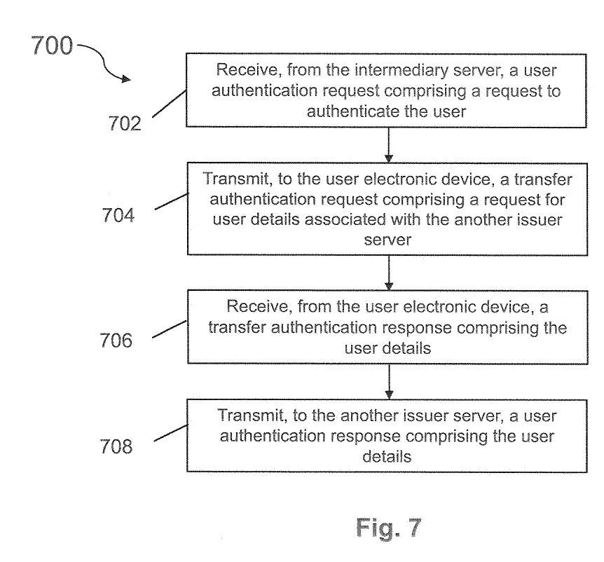

FIG. 7 shows steps of a method 700 for authenticating the user, as carried out by the issuer server 104 in accordance with an embodiment of the invention.

In a step 702, the issuer server 104 is configured to receive, from the intermediary server 106, a user authentication request comprising a request to authenticate the user.

In a step 704, the issuer server 104 is configured to transmit, to the user electronic device 102, a transfer authentication request comprising a request for user details associated with the another issuer server 108 to authenticate the user. The user details may comprise at least a user name and a personal identification number (PIN) or a password associated with the user which is registered with the another issuer server 108. The PIN or password may comprise a string of numbers, symbols or alphanumeric characters. In some embodiments, the PIN may consist of a string of 3 or 4 numbers.

In a step 706, the issuer server 104 is configured to receive, from the user electronic device 102, a transfer authentication response comprising the user details associated with the another issuer server 108.

In a step 708, the issuer server 104 is configured to transmit, to the another issuer server 108, a user authentication response comprising the user details. In some embodiments, the user authentication response is transmitted from the issuer server 104 to the another issuer server 108 via the intermediary server 106. Upon receiving the user details from the issuer server 104, the another issuer server 108 may be configured to verify the user details using the second issuer database 114. The user may be authenticated by the another issuer server 108 if the user details received from the intermediary server 106 match those stored in the second issuer database 114.

In some embodiments, a second-factor authentication process is used to further authenticate the user prior to processing the export request by the another issuer server 108. The second-factor authentication may comprise the another issuer server 108 transmitting a dynamic one-time password (OTP) to the user electronic device 102. The user is authenticated if the OTP received by the another issuer server 108 is verified by the another issuer server 108. The OTP may be transmitted to the another issuer server 108 directly from the issuer server 104 or via the intermediary server 106. In these cases, the export request is fulfilled if the second-factor authentication process is successful.

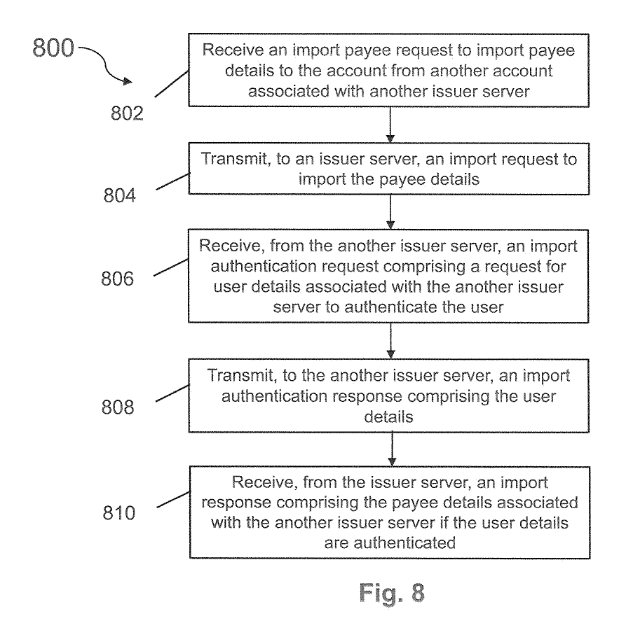

FIG. 8 shows steps of a method 800 for importing payee details to the account associated with the user, as carried out by the user electronic device 102 in accordance with an embodiment of the invention.

In a step 802, the user electronic device 102 is configured to receive, an import payee request to import payee details to the account (e.g. the first account associated with the issuer server 104) from another account (e.g. the second account) associated with another issuer server 108. The import payee request comprises at least the issuer identifier associated with the another issuer server 108. In some embodiments, the import payee request is received via e.g. the first account which the user has logged into using a suitable App or a webpage on the user electronic device 102. The import payee request may be initialised by the user by selecting e.g. an import payee function on an application programming interface (API) associated with the first account.

In a step 804, the user electronic device 102 is configured to transmit, to the issuer server 104, an import request. The import request is a request to import the payee details from the another issuer server and comprises at least an account identifier associated with the another issuer server and the issuer identifier. The account identifier may comprise at least one of an account number or an account name associated with the another issuer server 108.

In a step 806, the user electronic device 102 is configured to receive, from the another issuer server 108, an import authentication request comprising a request for user details associated with the another issuer server 108 to authenticate the user. The user details may comprise at least a user name associated and a personal identification number (PIN) or a password associated with the user which is registered with the another issuer server 108. The PIN or password may comprise a string of numbers, symbols or alphanumeric characters. In some embodiments, the PIN may consist of a string of 3 or 4 numbers.

In a step 808, the user electronic device 102 is configured to transmit, to the another issuer server 108, an import authentication response comprising the user details. In some embodiments, a second-factor authentication process is used to further authenticate the user prior to processing the export request by the another issuer server 108. The second-factor authentication may comprise the another issuer server 108 transmitting a dynamic one-time password (OTP) to the user electronic device 102. The user is authenticated if the OTP received by the another issuer server 108 is verified by the another issuer server 108. The OTP may be transmitted to the another issuer server 108 using the user electronic device 102 via the issuer server 104 and the intermediary server 106 or directly via the issuer server 104. In these cases, the export request is fulfilled if the second-factor authentication process is successful.

In a step 810, the user electronic device 102 is configured to receive, from the issuer server 104, an import response comprising the payee details associated with the another issuer server 108 if the user details are authenticated. In some embodiments, the payee details comprises a list of payees associated with the user that is registered with the another issuer server 108. In these cases, the user electronic device 102 may prompt the user to select payees, the payee details for which are to be imported to e.g. the first account. In some embodiments, there may be displayed on the API a checkbox associated with each of the payees where the user can check to select the payees. In other embodiments, payees can be selected using the user electronic device 102 by clicking on the payees displayed. The selected payees may appear highlighted or bold. Once the payees are selected, the user may import the selected payees to the first account (e.g. this may be done by effecting an option to import the payees as displayed on the user electronic device 102).

In some embodiments, the import response comprises all registered payee information associated with the another server 108. In these cases, the user electronic device 102 may prompt the user to select some or all of the registered payees imported to the issuer server 104 to be associated with the first account.

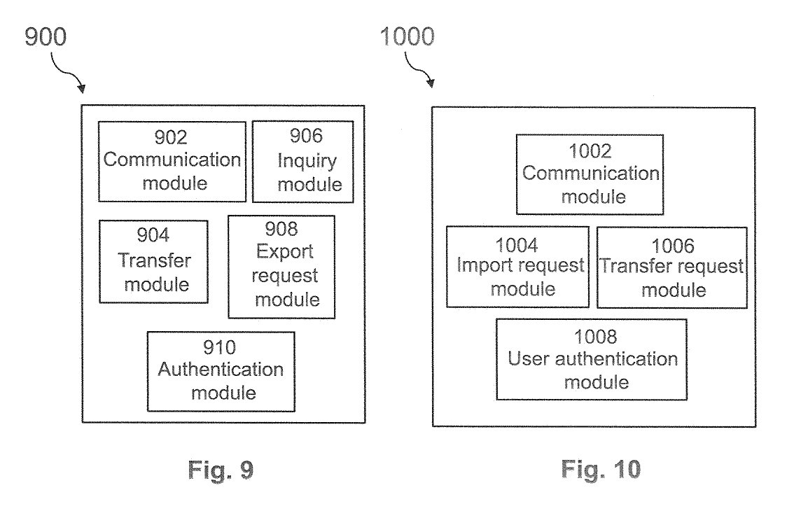

FIG. 9 shows schematically a structure 900 of the intermediary server 106 comprised in the computerised system 100 in accordance with embodiments of the invention. The structure 900 of the intermediary server 106 comprises at least a communication module 902, a transfer module 904, an inquiry module 906, an export request module 908 and an authentication module 910.

The communication module 902 is configured to enable the intermediary server 106 to communicate with at least the issuer server 104 and the another issuer server 108 as provided in the computerised system 100. The communication module 902 is configured to work in tandem with other modules of the intermediary server 106 as discussed in more detail below.

The transfer module 904 is configured to receive a transfer request from the issuer server 104. The transfer request comprises a request to import payee details from the another issuer server 108 and at least the account identifier and the issuer identifier associated with the another issuer server 108. The transfer module 904 is configured to transmit a transfer response comprising the payee details associated with the another issuer server 108 to the issuer server 104. In some embodiments where the payee details comprises a list of payees associated with the another issuer server 108, the transfer module 904 is configured to transmit, to the issuer server 104, a selection request comprising a request to select from the list of payees, at least one payee, the payee details for which are to be imported to the issuer server 104, and to receive a selection response comprising the at least one payee from the issuer server 104. In some embodiments, the account identifier comprises at least one of an account number or account name associated with the another issuer server 108.

The inquiry module 906 is configured to use the communication module 902 to query the intermediary database 112 to identify the another issuer server 108 using the issuer identifier.

The export request module 908 is configured to transmit, to the another issuer server 108, an export request to export the payee details from the another issuer server 108. The export request comprises at least the account identifier. The export request module 908 is configured to receive an export response comprising the payee details from the another issuer server 108. In some embodiments where the payee details comprise a list of payees associated with the another issuer server 108, the export request module 908 is configured to transmit, to the another issuer server 108, a selected export request comprising a request to export selected payee details associated with the at least one payee, and to receive, from a selected export response comprising the selected payee details from the another issuer server 108. In some embodiments, the export request comprises an export parameter indicating that the export request is a request to export the payee details.

The authentication module 910 is configured to authenticate the user prior to completing the import of the payee details to the account. In some embodiments, the authentication module 910 is configured to receive an authentication request comprising a request to authenticate the user from the another issuer server 108. The authentication module 910 may be configured to transmit a user authentication request comprising a request for user details to the issuer server 104, where the user details are associated with the another issuer server 108. The authentication module 910 may be configured to receive a user authentication response comprising the user details from the issuer server 104 and to transmit an authentication response comprising the user details to authenticate the user to the another issuer server 108.

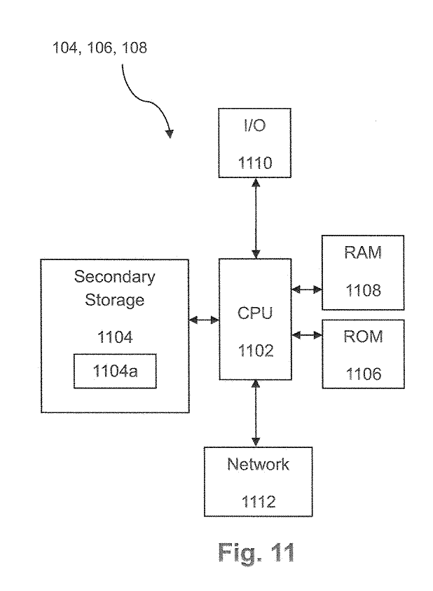

FIG. 10 shows schematically a structure 1000 of the issuer server 104 comprised in the computerised system 100 in accordance with embodiments of the invention. The structure 1000 of the issuer server 104 comprises a communication module 1002, an import request module 1004, a transfer request module 1006 and a user authentication module 1008.

The communication module 1002 is configured to allow the issuer server 104 to communicate with at least the user electronic device 102 and the intermediary server 106 as provided in the computerised system 100. The communication module 1002 may be configured to enable the issuer server 104 to communicate with the issuer database 110 and the another issuer server 108. The communication module 1002 is configured to work in tandem with other modules of the issuer server 104 as discussed in more detail below.

The import request module 1004 is configured to receive an import request from the user electronic device 102, where the import request is a request to import payee details from the another issuer server 108 and comprises at least the account identifier and the issuer identifier associated with the another issuer server 108. The import request module 1004 is configured to transmit an import response comprising the payee details associated with the another issuer server to the user electronic device 102. In some embodiments, the account identifier comprises at least one of an account number or account name associated with the another issuer server 108.

The transfer request module 1006 is configured to transmit, to an intermediary server 106, a transfer request, where the transfer request is a request to import the payee details from the another issuer server 108 and comprises at least the account identifier and the issuer identifier. The transfer request module 1006 is configured to receive a transfer response comprising the payee details associated with the another issuer server from the intermediary server 106. In some embodiments where the payee details comprises a list of payees associated with the another issuer server 108, the transfer request module 1006 is configured to transmit, to the user electronic device 102, a payee selection request comprising a request to select from the list of payees, at least one payee, the payee details for which are to be imported to the account. In these cases, the transfer request module 1006 is configured to receive a payee selection response comprising the at least one payee from the user electronic device 102.

The user authentication module 1008 is configured to receive a user authentication request comprising a request to authenticate the user from the intermediary server 106. Upon receiving the user authentication request, the user authentication module 1008 is configured to transmit, to the user electronic device 102, a transfer authentication request comprising a request for user details associated with the another issuer server 108 to authenticate the user. The user authentication module 1008 is configured to receive a transfer authentication response comprising the user details associated with the another issuer server 108 from the user electronic device 102. The user authentication module 1008 is configured to transmit a user authentication response comprising the user details to the another issuer server 108. In some embodiments, the user authentication response may be transmitted to the another issuer server 108 via the intermediary server 106.

FIG. 11 is a block diagram showing a technical architecture of the intermediary server 106. The issuer server 104 and/or the another issuer server 108 may also have this technical architecture.

The technical architecture includes a processor 1102 (which may be referred to as a central processor unit or CPU) that is in communication with memory devices including secondary storage 1104 (such as disk drives), read only memory (ROM) 1106, and random access memory (RAM) 1108. The processor 1102 may be implemented as one or more CPU chips. The technical architecture may further comprise input/output (I/O) devices 1110, and system connectivity devices 1112.

The secondary storage 1104 is typically comprised of one or more disk drives or tape drives and is used for non-volatile storage of data and as an over-flow data storage device if RAM 1108 is not large enough to hold all working data. Secondary storage 1104 may be used to store programs which are loaded into RAM 1108 when such programs are selected for execution.

In this embodiment, the secondary storage 1104 has a processing component 1104a comprising non-transitory instructions operative by the processor 1102 to perform various operations of the method of the present disclosure. The ROM 1106 is used to store instructions and perhaps data which are read during program execution. The secondary storage 1104, the RAM 1108, and/or the ROM 1106 may be referred to in some contexts as computer readable storage media and/or non-transitory computer readable media.

I/O devices 1110 may include printers, video monitors, liquid crystal displays (LCDs), plasma displays, touch screen displays, keyboards, keypads, switches, dials, mice, track balls, voice recognizers, card readers, paper tape readers, or other input devices.

The system connectivity devices 1112 may take the form of modems, modem banks, Ethernet cards, universal serial bus (USB) interface cards, serial interfaces, token ring cards, fiber distributed data interface (FDDI) cards, wireless local area system (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other system devices. These system connectivity devices 1112 may enable the processor 1112 to communicate with the Internet or one or more intranets. With such a system connection, it is contemplated that the processor 1102 might receive information from the system, or might output information to the system in the course of performing the above-described method operations. Such information, which is often represented as a sequence of instructions to be executed using processor 1102, may be received from and outputted to the system, for example, in the form of a computer data signal embodied in a carrier wave.

The processor 1102 executes instructions, codes, computer programs, scripts which it accesses from hard disk, floppy disk, optical disk (these various disk based systems may all be considered secondary storage 1104), flash drive, ROM 1106, RAM 1108, or the system connectivity devices 1112. While only one processor 1102 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing an application and/or applications in a cloud computing environment. Cloud computing may comprise providing computing services via a system connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 1102, the RAM 1108, and the ROM 1106 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. An intermediary server for importing payee details into an account associated with a user, the intermediary server comprising:
a transfer module configured to:
receive, from an issuer server, a transfer request comprising a request to import payee details from another issuer server and at least an account identifier and an issuer identifier associated with the another issuer server; and
transmit, to the issuer server, a transfer response comprising the payee details associated with the another issuer server;
an inquiry module configured to:
query an intermediary database to identify the another issuer server using the issuer identifier; and
an export request module configured to:
transmit, to the another issuer server an export request to export the payee details from the another issuer server, the export request comprising at least the account identifier; and
receive, from the another issuer server, an export response comprising the payee details.

2. The intermediary server of claim 1, wherein the payee details comprise a list of payees associated with the another issuer server, and the transfer module is further configured to:
transmit, to the issuer server, a selection request comprising a request to select from the list of payees, at least one payee, the payee details for which are to be imported to the issuer server; and
receive, from the issuer server, a selection response comprising the at least one payee; and
wherein the export request module is further configured to:
transmit, to the another issuer server, a selected export request comprising a request to export selected payee details associated with the at least one payee; and
receive, from the another issuer server, a selected export response comprising the selected payee details.

3. The intermediary server of claim 2 further comprising:
an authentication module configured to:
receive, from the another issuer server, an authentication request comprising a request to authenticate the user;
transmit, to the issuer server, a user authentication request comprising a request for user details, the user details being associated with the another issuer server;
receive, from the issuer server, a user authentication response comprising the user details; and
transmit, to the another issuer server, an authentication response comprising the user details to authenticate the user.

4. The intermediary server of claim 3, wherein the account identifier comprises at least one of an account number or an account name associated with the another issuer server.

5. The intermediary server of claim 4, wherein the export request further comprises an export parameter indicating that the export request is a request to export the payee details.

6. The intermediary server of claim 2, wherein the account identifier comprises at least one of an account number or an account name associated with the another issuer server.

7. The intermediary server of claim 2, wherein the export request further comprises an export parameter indicating that the export request is a request to export the payee details.

8. The intermediary server of claim 1 further comprising:
an authentication module configured to:
receive, from the another issuer server, an authentication request comprising a request to authenticate the user;
transmit, to the issuer server, a user authentication request comprising a request for user details, the user details being associated with the another issuer server;
receive, from the issuer server, a user authentication response comprising the user details; and
transmit, to the another issuer server, an authentication response comprising the user details to authenticate the user.

9. The intermediary server of claim 1, wherein the account identifier comprises at least one of an account number or an account name associated with the another issuer server.

10. The intermediary server of claim 1, wherein the export request further comprises an export parameter indicating that the export request is a request to export the payee details.

11. An issuer server for importing payee details into an account associated with a user, the issuer server comprising:
an import request module configured to:
receive, from a user electronic device, an import request, the import request is a request to import payee details from another issuer server and comprises at least an account identifier and an issuer identifier associated with the another issuer server; and
transmit, to the user electronic device, an import response comprising the payee details associated with the another issuer server; and
a transfer request module configured to:
transmit, to an intermediary server, a transfer request, where the transfer request is a request to import the payee details from the another issuer server and comprises at least the account identifier and the issuer identifier; and
receive, from the intermediary server, a transfer response comprising the payee details associated with the another issuer server.

12. The issuer server of claim 11, wherein the payee details comprise a list of payees associated with the another issuer server, the import request module is further configured to:
transmit, to the user electronic device, a payee selection request comprising a request to select from the list of payees, at least one payee, the payee details for which are to be imported to the account; and
receive, from the user electronic device, a payee selection response comprising the at least one payee.

13. The issuer server of claim 12 further comprising:
a user authentication module configured to:
receive, from the intermediary server, a user authentication request comprising a request to authenticate the user;
transmit, to the user electronic device, a transfer authentication request comprising a request for user details associated with the another issuer server to authenticate the user;
receive, from the user electronic device, a transfer authentication response comprising the user details associated with the another issuer server; and
transmit, to the another issuer server, a user authentication response comprising the user details.

14. The intermediary server of claim 13, wherein the account identifier comprises at least one of an account number or account name associated with the another issuer server.

15. The intermediary server of claim 12, wherein the account identifier comprises at least one of an account number or account name associated with the another issuer server.

16. The issuer server of claim 11 further comprising:
a user authentication module configured to:
receive, from the intermediary server, a user authentication request comprising a request to authenticate the user;
transmit, to the user electronic device, a transfer authentication request comprising a request for user details associated with the another issuer server to authenticate the user;
receive, from the user electronic device, a transfer authentication response comprising the user details associated with the another issuer server; and
transmit, to the another issuer server, a user authentication response comprising the user details.

17. The intermediary server of claim 11, wherein the account identifier comprises at least one of an account number or account name associated with the another issuer server.

18. A computer-implemented method for importing payee details into an account associated with a user, the method being carried out at a user electronic device and comprises:
receiving, an import payee request to import payee details to the account from another account associated with another issuer server, the import payee request comprising at least an issuer identifier associated with the another issuer server;
transmitting, to an issuer server, an import request, the import request is a request to import the payee details from the another issuer server and comprises at least an account identifier associated with the another issuer server and the issuer identifier;
receiving, from the another issuer server, an import authentication request comprising a request for user details associated with the another issuer server to authenticate the user;
transmitting, to the another issuer server, an import authentication response comprising the user details; and
receiving, from the issuer server, an import response comprising the payee details associated with the another issuer server if the user details are authenticated.

19. A non-transitory computer-readable medium having stored thereon program instructions for causing at least one processor to perform the method according to claim 18.
